(19) United States
(12) Patent Application Publication
(10) Pub. No.: US 2007/0259116 A1
(43) Pub. Date: Nov. 8, 2007

(54) Partially coated workpiece and method of making same

(75) Inventors: Robert Nolan, Knocknacarra (IE); Dave McMorrow, Galway City (IE); Timothy O'Connor, Claregalway (IE); Barry Heaney, Ballybrit (IE); Aiden Flanagan, Kilcolgan (IE); Anthony Malone, Oranmore (IE); James McGovern, Eden Prairie, MN (US)

Correspondence Address: KENYON & KENYON LLP, 1500 K STREET N.W., SUITE 700, WASHINGTON, DC, 20005, US

(73) Assignee: BOSTON SCIENTIFIC SCIMED, INC.

(21) Appl. No.: 11/415,111

(22) Filed: May 2, 2006

(51) Int. Cl. B05D 1/32

(52) U.S. Cl. 427/282; 427/272

(57) ABSTRACT

The present invention is directed to methods and processes for coating portions of a workpiece as well as to workpieces that have themselves been coated with one or more of these processes. Under these methods and processes a masking material may be positioned over a portion of a workpiece prior to applying coating to the workpiece. Once the coating is applied this masking may be removed to expose a portion of the workpiece that has not been coated.

### TECHNICAL FIELD

The present invention generally regards methods of coating portions of a workpiece and workpieces that have been coated with this method. More specifically, the present invention relates to methods of coating selected surfaces of a workpiece, with removably masking materials, such that outside faces of the workpiece, which may be an implantable medical device, may be selectively coated when the process is completed.

### BACKGROUND

Coating workpieces is an often repeated procedure in contemporary manufacturing. Workpieces may be coated by methods that include tumble coating, spray coating, and electrostatic spraying. During each of these procedures a coating is applied to the workpiece prior to the workpiece being used for an intended purpose.

When the workpiece is formed partially or completely out of lattice struts or some other open framework, each of the faces of these struts or framework is exposed to the coating and coated during the coating methods listed above. By exposing each face of the workpiece to the coating being applied, each exposed face will be covered during the coating process.

When the workpiece being coated is an implantable medical device, such as a stent, all faces of the struts that comprise the stent are coated when using the coating systems identified above. For example, when tumble coating is used, each face of the stent struts will be exposed to the coating. This coating will remain when the stent is removed from the dip and will dry on each face of the struts. Coating may also remain in the spaces between the struts. This phenomenon is sometimes called webbing. Here, not only are the individual struts covered, but some or all of the spaces between the struts are spanned by the coating as well.

### BRIEF DISCUSSION OF THE INVENTION

The present invention is directed to methods and processes for coating portions of a workpiece as well as to workpieces that have themselves been coated with one or more of these processes. Under these methods and processes a masking material may be positioned over a portion of a workpiece prior to applying coating to the workpiece. Once the coating is applied this masking may be removed to expose a portion of the workpiece that has not been coated. In some embodiments the workpiece may be an implantable medical device and the coating may include a therapeutic.

### BRIEF DESCRIPTION OF THE DRAWINGS

Referring to the drawings which form a part of this disclosure:

FIG. 1a is a cross-sectional view of a portion of a coated strut of a lattice from a workpiece that has been coated in accord with the present invention;

FIG. 1b is a cross-sectional view showing the coated strut of FIG. 1 after a second coating has been applied as may be employed in accord with embodiments of the present invention;

FIG. 1c is a side-view showing an arterial stent that may be coated in accord with embodiments of the present invention;

FIGS. 2a and 2b are cross-sectional views showing a side and end view of a workpiece positioned within a mold and covered with a masking material as may be employed in accord with embodiments of the present invention;

FIG. 2c is cross-sectional view showing an end view of a workpiece positioned within a sheath and covered with a masking material as may be employed in accord with embodiments of the present invention;

FIG. 2d is cross-sectional view showing a mold positioned within a workpiece and covered with a masking material as may be employed in accord with embodiments of the present invention;

FIG. 3a shows a perspective view of the workpiece from FIGS. 2a and 2b after it has been removed from the mold;

FIG. 3b is a partial cross-sectional view taken along line 3-3 of FIG. 3a;

FIG. 4 shows a perspective view of a spraying nozzle, a charged coating, a ground wire, and a grounded or electrically charged workpiece covered with a masking material as may be used in accord with embodiments of the present invention;

FIG. 5a is a cross-sectional end view of the workpiece from FIG. 4 after it has been coated in accord with embodiments of the present invention;

FIG. 5b is a cross-sectional end view of a workpiece that has been dip coated or spray coated in accord with embodiments of the present invention;

FIG. 6 shows a manner in which masking material may be removed from a coated workpiece in accord with embodiments of the present invention;

FIG. 7 shows a manner in which “webbing” may be removed in accord with embodiments of the present invention;

FIG. 8a is a cross-sectional view of a workpiece covered with a masking material and located within a mold having protrusions in accord with embodiments of the present invention;

FIG. 8b is cross-sectional view of an end view of the workpiece of FIG. 8a after the mold is removed in accord with embodiments of the present invention;

FIG. 8c is a cross-sectional view showing the workpiece of FIGS. 8a and 8b after electrostatic coating and removal of the masking material in accord with embodiments of the present invention;

FIG. 8d shows an embodiment of the present invention in which a second mold is used to coat the workpiece;

FIG. 9a shows a cross-sectional end view of a workpiece covered with a masking material and located within a mold in accord with embodiments of the present invention; and

FIG. 9b, 9c, and 9d show cross sectional side views of a strut of the workpiece of FIG. 9a with coating steps that may be employed in accord with embodiments of the present invention.

### DETAILED DESCRIPTION

Methods that embody the present invention may be used to coat one or more surfaces of a workpiece while not coating other surfaces of the workpiece. In some embodiments this may include coating the outside surface of the struts of a stent. By coating in this fashion the amount of coating resident on the stent is reduced. If this coating contains a therapeutic, this reduction in coating may allow the therapeutic to be delivered in a more targeted fashion after the stent is implanted in a patient because it is only resident on some but not all faces of the struts of the stent. This selective coating of a workpiece may be accomplished in accord with embodiments of the present invention by placing the workpiece in a mold, covering a portion of the workpiece with a masking material, coating unmasked portions of the workpiece and then removing the masking material from the workpiece.

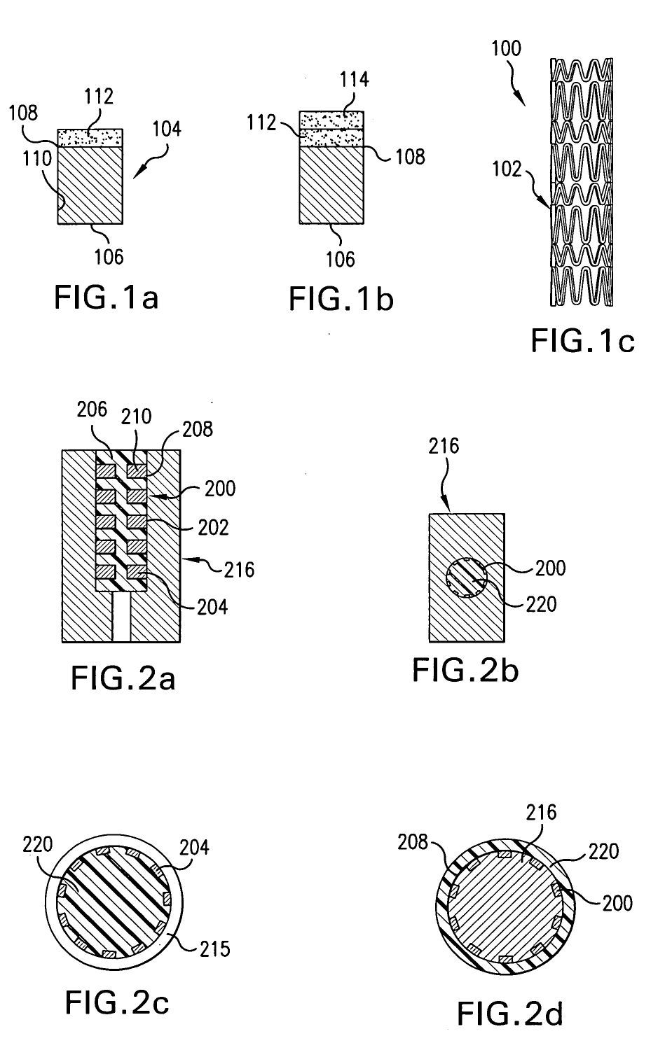

Referring initially to FIGS. 1a, 1b, and 1c, a strut 104 of a lattice portion 102 of a workpiece 100, which in this case is a coronary artery stent, is illustrated.

This stent may be self-expanding, mechanically expandable, or a hybrid stent which may have both self-expanding and mechanically expandable characteristics. The stent may be made in a wide variety of designs and configurations, and may be made from a variety of materials including plastics and metals.

Various methods may be employed for delivery and implantation of the stent. For instance, a self-expanding stent may be positioned at the distal end of a catheter around a core lumen. Self-expanding stents may be typically held in an unexpanded state during delivery using a variety of methods including sheaths or sleeves which cover all or a portion of the stent. When the stent is in its desired location of the targeted vessel the sheath or sleeve is retracted to expose the stent which then self-expands upon retraction.

Another method includes mounting a mechanically expandable stent on an expandable member, such as a dilatation balloon provided on the distal end of an intravascular catheter, advancing the catheter through a patient's vasculature to the desired location within the patient's body lumen, and inflating the balloon on the catheter to expand the stent into a permanent expanded condition.

One method of inflating the balloon includes the use of inflation fluid. The expandable member is then deflated and the catheter removed from the body lumen, leaving the stent in the vessel to hold the vessel open.

The strut 104 has an inner diameter 106, an outer diameter 108, and a plurality of cut faces 110. A coating 112 is shown applied to the workpiece 100. This coating has been applied to coat a target surface of the strut 104 as shown in FIG. 1a. In the instant case, the target surface is the outer diameter 108; however, any surface may be targeted for coating. Moreover, as seen in FIG. 1b, a second coating 114 or multiple coatings may be applied to the coated surface of the strut 104 and/or workpiece 100 in accord with the present invention.

In addition to being embodied in a workpiece and other physical devices the present invention may also be embodied in certain methods. These methods may be carried out on medical devices and other workpieces.

In some instances the workpiece may be a medical device, such as a stent that may be implanted into the body of a patient. In addition, these workpieces may be fabricated from various materials including conductive materials, such as conductive ceramic, polymeric, metallic materials. The workpieces can be any suitable size and/or shape, including polygonal or irregular shapes.

Medical implants and devices that embody the invention may be used for innumerable medical purposes, including the reinforcement of recently re-enlarged lumens, the replacement of ruptured vessels, and the treatment of disease such as vascular disease by local pharmacotherapy, i.e., delivering therapeutic drug doses to target tissues while minimizing systemic side effects. Such localized delivery of therapeutic agents has been proposed or achieved using medical implants which both support a lumen within a patient's body and place appropriate coatings containing absorbable therapeutic agents at the implant location. Examples of such medical devices include catheters, guide wires, balloons, filters (e.g., vena cava filters), stents, stent grafts, vascular grafts, intraluminal paving systems, implants and other devices used in connection with drug-loaded polymer coatings. Such medical devices are implanted or otherwise utilized in body lumina and organs such as the coronary vasculature, esophagus, trachea, colon, biliary tract, urinary tract, prostate, brain, and the like.

As illustrated in FIGS. 2a and 2b, an initial step of a method embodying the invention may include providing a workpiece 200 having a lattice portion 202 with a plurality of struts 204. It may also include inserting the workpiece 200 into a mold 216 that may cover the outside diameter 208 of the workpiece 200. This mold may be a casting mold and may be expandable and/or comprised of two-halves. The mold 216 may also include a channel 218 to receive an ejector element. The ejector element may be used to force the workpiece 200 out of the mold 216. Additionally, the mold 216 can be sized to match the size of the workpiece 200.

The mold 216 may be slightly larger than the workpiece. If the mold 216 is slightly larger than the workpiece 200, the workpiece 200 can be expanded with pressure, such as with an inflatable balloon, to contact the inner surface of the mold 216.

Another step in a method embodying the invention may include preventing a target surface of the lattice portion 202 from being coated. Here, the lattice portion 202 may be filled with a mask material 220 by injection. Consequently, upon injection, the mask material 220 can cover the inner diameter 206 and the cut faces 210. However, due to the positioning of the mold 216, the outside diameter 208 may not be covered by the masking material 220.

Although the preceding example illustrates the workpiece 200 being filled with a mask material by injection, and the mold 216 covering the outer diameter of the strut 204, the embodiments of the present invention are not limited thereto and alternative arrangements may also fall within the scope of the invention. For example, as shown in FIG. 2d, a properly configured mold 216 may be placed inside the workpiece 200 to cover the inner diameter 206. Accordingly, in this case, the mask material 220 may then be positioned so as to cover the outer diameter 208 and/or the cut faces 210. Furthermore, other suitable types and arrangements of molds are also plausible and fall within the scope of the invention. For example, FIG. 2c shows an instance where a sheath 215 is used as a casting mold. The sheath 215 may be made of a resilient material, so as to expand or contract to accommodate the size of the workpiece 200. In this instance, the sheath may be shrunk fit to cover an outside surface of the workpiece 200 prior to the injection of masking material into the workpiece.

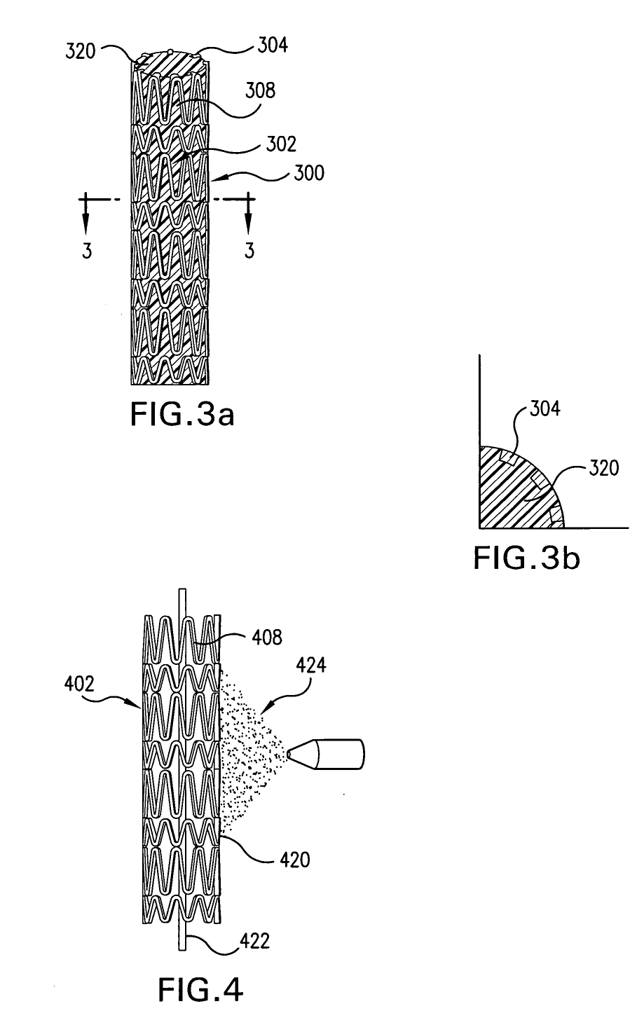

In FIGS. 3a and 3b, a mask material 320 that solidifies within the lattice portion 302 and between the struts 304 is shown. Upon solidification, the mold 216 may be removed from the workpiece 300. At this time, the outside diameter 308 of the lattice portion 302 may be exposed and ready to receive the coating.

Any suitable mask material 320 may be used. The characteristics of the mask material 320 may preferably include being water soluble, having solid state characteristics at low temperatures, and having liquid state characteristics at slightly elevated temperatures. Furthermore, the mask material 320 preferably operates in a temperature range which does not risk the denaturing of the characteristics of the coating. More particularly, wax may be used as the mask material 320. The wax preferably has a melting point of about 50° C. Other suitable alternatives for the mask material 320 include polyester wax (melting point of about 37° C.), polyethylene glycol (melting point of about 37-40° C.), an aquabond water soluble adhesive (melting point of about 55° C.), and water can also be used.

In FIG. 4, another step of a method is illustrated. This step involves applying a coating to the target surface of the lattice portion 402. In this example, the surface is the outer diameter 408 of the lattice portion 402. The coating of the outer diameter 408 can be applied to the lattice portion 402 by various methods including, but not limited to, dipping, spraying, rolling, brushing, electrostatic plating or spinning, vapor deposition, air spraying including atomized spray coating, and spray coating using an ultrasonic nozzle. Some of these coating methods are described in U.S. Pat. No. 6,861,088 to Weber et. al, the entire disclosure of which is hereby incorporated by reference.

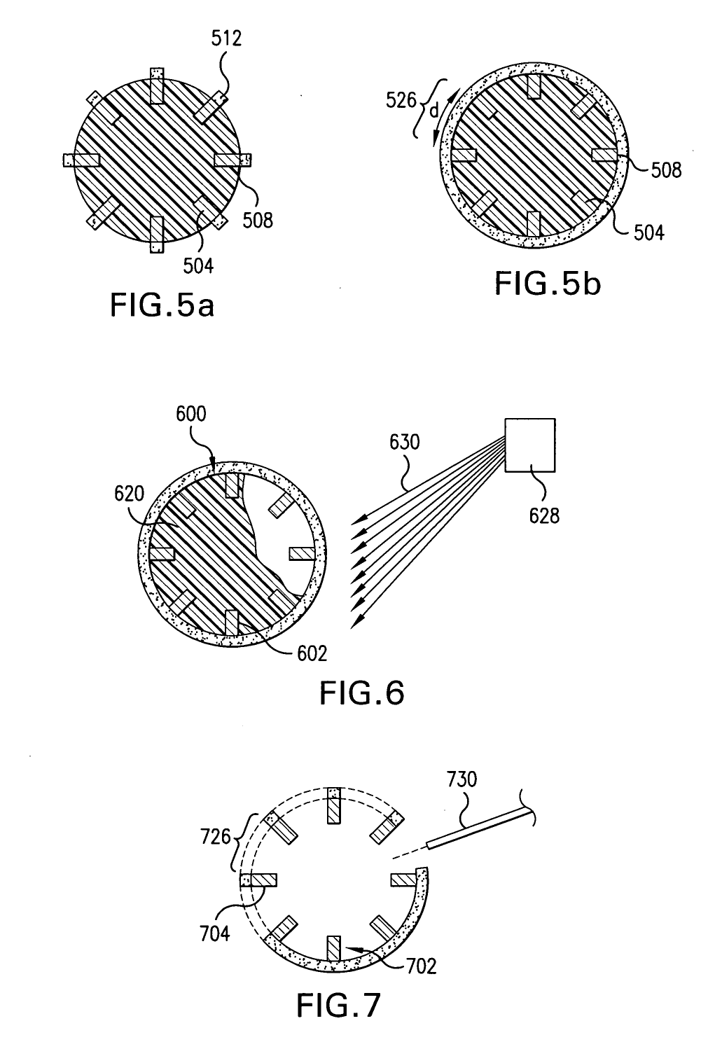

In FIG. 4, the lattice portion 402 is coated electrostatically. Electrostatic coating may be effective in providing a uniform coating to each individual strut 404. To use the electrostatic application, the lattice portion 402 may be initially grounded or charged. The lattice portion 402 may be grounded utilizing a ground wire 422; however, the invention is not limited thereto, and any number of alternative grounding or charging configurations can be envisioned. As a result, the lattice portion 402 may become electrically neutral; the coating 424 may be positively charged. Therefore, the coating 424 may preferably be attracted only to the targeted surface of the grounded lattice portion 402. In this case, the coating 424 should be attracted to the outer diameter 408. Further, the amount of coating 424 entering the interior of the lattice portion 402 can be minimized because of the physical presence of the mask material 420. As a result, as seen in FIG. 5a, the outer diameter 508 of each strut 504 is coated 512.

When the coating 424 is applied by dip or spray coating, the step of grounding or charging the lattice portion 402 may not be necessary. As seen in FIG. 5b, when dip or spray coating, not only may the outer diameter 508 of the strut 504 be coated, but the distance (d) or gaps between adjacent struts 504 can also be coated. This phenomenon is known in the art as “webbing.” This phenomenon will be discussed in more detail below.

As stated above, multiple layers of the coating may be applied to the lattice portion 402 and the webbing 526. Additionally, various thicknesses, types, and other properties of the coating may be used when practicing the present invention.

As seen in FIG. 6, thermal energy 630 may be applied to the workpiece 600 and/or lattice portion 602, such as through a heating source 628. In the example, thermal energy 630 may be used to melt the mask material 620. The liquefied mask material 620 can then be removed. For example, if wax were used as the mask material 620, the wax may be removed as lost wax. Any of a variety of thermal energy applications or alternatives can be used to remove the mask material 620.

It may also be desirable to apply mechanical energy to the workpiece 600 and/or lattice portion 602. The application of mechanical energy may also facilitate the removal of mask material 620. Mechanical energy application means that may be used including, for example, oscillation. Additionally, mask material 620 may be removed from the workpiece 600 by rinsing with a liquid such as water and/or a solvent. Other removal applications may also be possible.

As explained herein above, and as shown in FIG. 7, when the lattice portion 702 is dip or spray coated, webbing 726 can result. The webbing 726 extends between adjacent struts 704. Webbing 726, in certain instances, can be undesirable. For example, window panes 726 can result in an uneven distribution of the coating and may result in drug “hotspots.” Therefore, in these circumstances, it may be desirable to remove the webbing 726 with a suitable removal device such as a laser 730. Other ablating techniques or devices may also be possible.

If webbing 726 is undesirable for a particular application, the laser ablation step illustrated in FIG. 7 or a suitable alternative may be used. The laser ablation step can be used to selectively ablate the webbing 726 from a surface of the lattice portion 702.

Comparatively, there are also instances in which the webbing is desirable. For example, webbing 726 can be used to facilitate endothethial regrowth. Moreover, webbing 726 can also be used to aid in the distribution of the polymer and/or therapeutic agent into the patient. Still further, webbing 726 can also be desirable if the workpiece is used as a graft. Consequently, either the removal, or non-removal, of the webbing 726 may be plausible in accord with the embodiments of the invention.

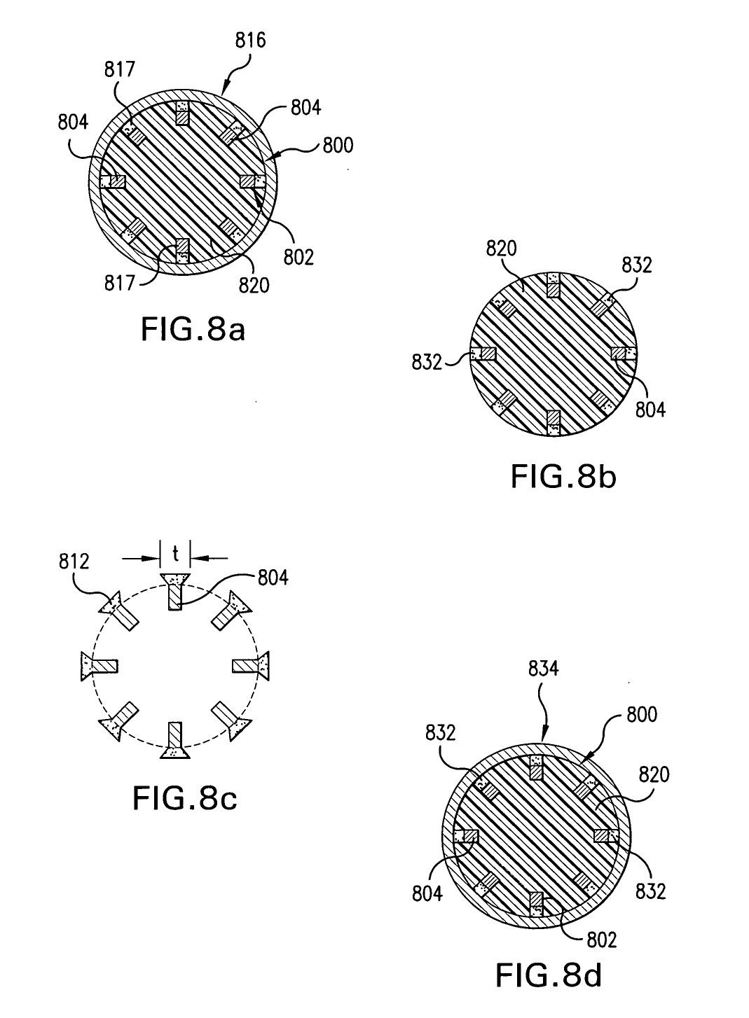

FIG. 8a shows a cross-sectional view of the workpiece 800 and lattice portion 802 covered with a mask material 820. In the example, the workpiece 800 is located within a mold 816 having protrusions 817. The mold 816 can be flexible or rigid. As evident to those skilled in the art, in conventional coating applications, the thickness of the coating 812 may be a function of the size and arrangement of the strut 804. Therefore, when the struts 804 are unevenly spaced or of different sizes, varying coating thicknesses may result. This may also lead to the previously described drug “hot spots.”

Therefore, as seen in FIG. 8a, protrusions 817 are positioned on the inner diameter of the mold 816. The protrusions 817 may be positioned so as to correspond to a strut 804 on the lattice portion 802. Depending on the size and shape of the protrusion 817, and not the strut 804, the thickness of the coating can be varied accordingly. In other words, the size and shape of the protrusions 817 can be used to tailor the coating thickness to a particular application irrespective of the size of the strut 804. A variety of other arrangements, sizes, and shapes of protrusions are plausible. For instance, in an application used to coat only an inner diameter of the lattice portion 802, a smaller mold 816 may be used in which the protrusions are located on the outside diameter.

In another example, as shown in FIG. 8c, substantially D-shaped protrusions 817 are used. In this example, the coating 812 thickness (t) is larger than the width of the strut. Alternatively, FIG. 8b illustrates an example in which the protrusions 817 are approximately the same size as the struts 804. After the mold 816 is removed, a U-shaped channel 832 is formed between the mask material 820 and each individual strut 804. Consequently, as seen in FIG. 8d, a second mold 834 (without protrusions) can then be positioned over the workpiece 800.

Once the second mold 834 is in place, a variety of types of coating applications can be used including pouring, injecting, or immersing the device into an ultrasonic bath. For example, if the coating is poured, the coating travels into the channels 832 formed between the second mold 834 and the struts 804. Subsequent to the application of the coating 812, the mask material is removed by the application of thermal energy and/or mechanical energy and rinsing. Non-limiting examples of thermal and mechanical energy examples were previously described herein in detail.

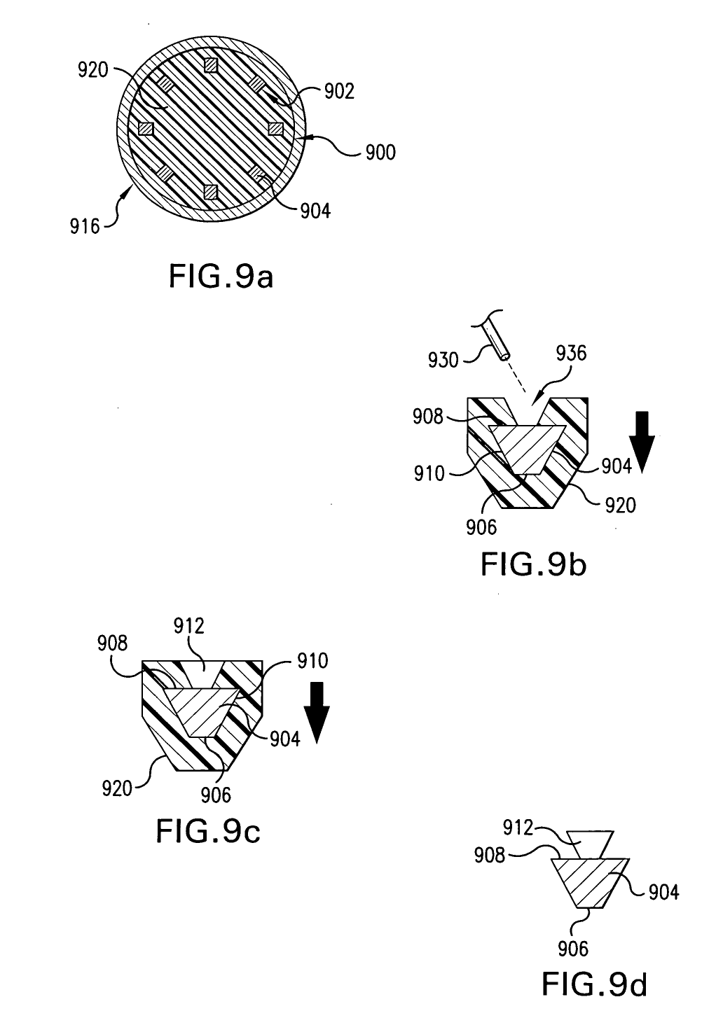

FIGS. 9a and 9b show a workpiece 900 and lattice portion 902 covered with a mask material 920. In accord with coating steps that may be employed with embodiments of the present invention, a workpiece 900 and lattice portion 902 including a plurality of struts 904 are provided. The mold 916 may be used to temporarily to encapsulate the workpiece 900, while the workpiece 900 is covered with a mask material 920. As a result, in the example, the entire lattice portion 902, including the inner diameter 906, the outer diameter 908, and the cut faces 910 are covered with the mask material 920. Any suitable mask material 920 may be used. Non-limiting examples of mask materials 920 were previously set forth herein and a duplicative list thereof will therefore be omitted.

As shown in FIGS. 9b, 9c, and 9d, after the lattice portion 902 is covered with the mask material 920 and the mask material 920 solidifies, portions of the mask material 920 can be selectively removed, however, other plausible arrangement may be used. For example, the mask material 920 may be sprayed on the workpiece 900. Spraying the mask material 920 on the workpiece 900 may, in certain instances, reduce the amount of mask material 920 utilized and facilitate its removal.

In the example illustrated, the mask material 920 is ablated by a laser 930 to form a recess 936 (FIG. 9b); however, any variety of ablating techniques and devices may be used. The size of the recess 936 depends upon the application of the device. The size of the recess 936 determines the coating thickness. Accordingly, in this example, the coating thickness can also be determined irrespective of the size of the strut. As shown in FIG. 9c, a coating 912 or any number of coatings may be subsequently applied to the recess 936.

As shown in FIG. 9d, a mask material 920 removal process is then performed to remove the remaining mask material 920. The mask material 920 removal process used in the example is the substantially the same as that described previously herein, and a duplicative description thereof will be omitted for purposes of clarity.

The coating, in accord with the embodiments of the present invention, may comprise a polymeric and or therapeutic agent formed, for example, by admixing a drug agent with a liquid polymer, in the absence of a solvent, to form a liquid polymer/drug agent mixture. A suitable list of drugs and/or polymer combinations is listed below. The term “therapeutic agent” as used herein includes one or more “therapeutic agents” or “drugs”. The terms “therapeutic agents” or “drugs” can be used interchangeably herein and include pharmaceutically active compounds, nucleic acids with and without carrier vectors such as lipids, compacting agents (such as histones), viruses (such as adenovirus, andenoassociated virus, retrovirus, lentivirus and α-virus), polymers, hyaluronic acid, proteins, cells and the like, with or without targeting sequences.

Specific examples of therapeutic agents used in conjunction with the present invention include, for example, pharmaceutically active compounds, proteins, cells, oligonucleotides, ribozymes, anti-sense oligonucleotides, DNA compacting agents, gene/vector systems (i.e., any vehicle that allows for the uptake and expression of nucleic acids), nucleic acids (including, for example, recombinant nucleic acids; naked DNA, cDNA, RNA; genomic DNA, cDNA or RNA in a non-infectious vector or in a viral vector and which further may have attached peptide targeting sequences; antisense nucleic acid (RNA or DNA); and DNA chimeras which include gene sequences and encoding for ferry proteins such as membrane translocating sequences (“MTS”) and herpes simplex virus-1 (“VP22”)), and viral, liposomes and cationic and anionic polymers and neutral polymers that are selected from a number of types depending on the desired application. Non-limiting examples of virus vectors or vectors derived from viral sources include adenoviral vectors, herpes simplex vectors, papilloma vectors, adeno-associated vectors, retroviral vectors, and the like. Non-limiting examples of biologically active solutes include anti-thrombogenic agents such as heparin, heparin derivatives, urokinase, and PPACK (dextrophenylalanine proline arginine chloromethylketone); antioxidants such as probucol and retinoic acid; angiogenic and anti-angiogenic agents and factors; anti-proliferative agents such as enoxaprin, angiopeptin, rapamycin, angiopeptin, monoclonal antibodies capable of blocking smooth muscle cell proliferation, hirudin, and acetylsalicylic acid; anti-inflammatory agents such as dexamethasone, prednisolone, corticosterone, budesonide, estrogen, sulfasalazine, acetyl salicylic acid, and mesalamine; calcium entry blockers such as verapamil, diltiazem and nifedipine; antineoplastic/antiproliferative/anti-mitotic agents such as paclitaxel, 5-fluorouracil, methotrexate, doxorubicin, daunorubicin, cyclosporine, cisplatin, vinblastine, vincristine, epothilones, endostatin, angiostatin and thymidine kinase inhibitors; antimicrobials such as triclosan, cephalosporins, aminoglycosides, and nitrofurantoin; anesthetic agents such as lidocaine, bupivacaine, and ropivacaine; nitric oxide (NO) donors such as linsidomine, molsidomine, L-arginine, NO-protein adducts, NO-carbohydrate adducts, polymeric or oligomeric NO adducts; anti-coagulants such as D-Phe-Pro-Arg chloromethyl ketone, an RGD peptide-containing compound, heparin, antithrombin compounds, platelet receptor antagonists, anti-thrombin antibodies, anti-platelet receptor antibodies, enoxaparin, hirudin, Warfarin sodium, Dicumarol, aspirin, prostaglandin inhibitors, platelet inhibitors and tick antiplatelet factors; vascular cell growth promotors such as growth factors, growth factor receptor antagonists, transcriptional activators, and translational promotors; vascular cell growth inhibitors such as growth factor inhibitors, growth factor receptor antagonists, transcriptional repressors, translational repressors, replication inhibitors, inhibitory antibodies, antibodies directed against growth factors, bifunctional molecules consisting of a growth factor and a cytotoxin, bifunctional molecules consisting of an antibody and a cytotoxin; cholesterol-lowering agents; vasodilating agents; agents which interfere with endogenous vascoactive mechanisms; survival genes which protect against cell death, such as anti-apoptotic Bcl-2 family factors and Akt kinase; and combinations thereof. Cells can be of human origin (autologous or allogenic) or from an animal source (xenogeneic), genetically engineered if desired to deliver proteins of interest at the insertion site. Any modifications are routinely made by one skilled in the art.

Polynucleotide sequences useful in practice of the invention include DNA or RNA sequences having a therapeutic effect after being taken up by a cell. Examples of therapeutic polynucleotides include anti-sense DNA and RNA; DNA coding for an anti-sense RNA; or DNA coding for tRNA or rRNA to replace defective or deficient endogenous molecules. The polynucleotides can also code for therapeutic proteins or polypeptides. A polypeptide is understood to be any translation product of a polynucleotide regardless of size, and whether glycosylated or not. Therapeutic proteins and polypeptides include as a primary example, those proteins or polypeptides that can compensate for defective or deficient species in an animal, or those that act through toxic effects to limit or remove harmful cells from the body. In addition, the polypeptides or proteins that can be injected, or whose DNA can be incorporated, include without limitation, angiogenic factors and other molecules competent to induce angiogenesis, including acidic and basic fibroblast growth factors, vascular endothelial growth factor, hif-1, epidermal growth factor, transforming growth factor ∀ and ∃, platelet-derived endothelial growth factor, platelet-derived growth factor, tumor necrosis factor ∀, hepatocyte growth factor and insulin like growth factor; growth factors; cell cycle inhibitors including CDK inhibitors; anti-restenosis agents, including p15, p16, p18, p19, p21, p27, p53, p57, Rb, nFkB and E2F decoys, thymidine kinase (“TK”) and combinations thereof and other agents useful for interfering with cell proliferation, including agents for treating malignancies; and combinations thereof. Still other useful factors, which can be provided as polypeptides or as DNA encoding these polypeptides, include monocyte chemoattractant protein (“MCP-1”), and the family of bone morphogenic proteins (“BMP's”). The known proteins include BMP-2, BMP-3, BMP-4, BMP-5, BMP-6 (Vgr-1), BMP-7 (OP-1), BMP-8, BMP-9, BMP-10, BMP-11, BMP-12, BMP-13, BMP-14, BMP-15, and BMP-16. Currently preferred BMP's are any of BMP-2, BMP-3, BMP-4, BMP-5, BMP-6 and BMP-7. These dimeric proteins can be provided as homodimers, heterodimers, or combinations thereof, alone or together with other molecules. Alternatively or, in addition, molecules capable of inducing an upstream or downstream effect of a BMP can be provided. Such molecules include any of the “hedgehog” proteins, or the DNA's encoding them.

As stated above, coatings used with the exemplary embodiments of the present invention may comprise a polymeric material/drug agent matrix formed, for example, by admixing a drug agent with a liquid polymer, in the absence of a solvent, to form a liquid polymer/drug agent mixture. Curing of the mixture typically occurs in-situ. To facilitate curing, a cross-linking or curing agent may be added to the mixture prior to application thereof. Addition of the cross-linking or curing agent to the polymer/drug agent liquid mixture must not occur too far in advance of the application of the mixture in order to avoid over-curing of the mixture prior to application thereof. Curing may also occur in-situ by exposing the polymer/drug agent mixture, after application to the luminal surface, to radiation such as ultraviolet radiation or laser light, heat, or by contact with metabolic fluids such as water at the site where the mixture has been applied to the luminal surface. In coating systems employed in conjunction with the present invention, the polymeric material may be either bioabsorbable or biostable. Any of the polymers described herein that may be formulated as a liquid may be used to form the polymer/drug agent mixture.

In accord with the embodiments, the polymer used to coat the medical device is provided in the form of a coating on an expandable portion of a medical device. After applying the drug solution to the polymer and evaporating the volatile solvent from the polymer, the medical device may be inserted into a body lumen where it is positioned to a target location. In the case of a balloon catheter, the expandable portion of the catheter may be subsequently expanded to bring the drug-impregnated polymer coating into contact with the lumen wall. The drug is released from the polymer as it slowly dissolves into the aqueous bodily fluids and diffuses out of the polymer. This enables administration of the drug to be site-specific, limiting the exposure of the rest of the body to the drug.

The polymer used in the exemplary embodiments of the present invention is preferably capable of absorbing a substantial amount of drug solution. When applied as a coating on a medical device in accordance with the present invention, the dry polymer is typically on the order of from about 1 to about 50 microns thick. In the case of a balloon catheter, the thickness is preferably about 1 to 10 microns thick, and more preferably about 2 to 5 microns. Very thin polymer coatings, e.g., of about 0.2-0.3 microns and much thicker coatings, e.g., more than 10 microns, are also possible. It is also within the scope of the present invention to apply multiple layers of polymer coating onto a medical device. Such multiple layers are of the same or different polymer materials.

The polymer of the present invention may be hydrophilic or hydrophobic, and may be selected from the group consisting of polycarboxylic acids, cellulosic polymers, including cellulose acetate and cellulose nitrate, gelatin, polyvinylpyrrolidone, cross-linked polyvinylpyrrolidone, polyanhydrides including maleic anhydride polymers, polyamides, polyvinyl alcohols, copolymers of vinyl monomers such as EVA, polyvinyl ethers, polyvinyl aromatics, polyethylene oxides, glycosaminoglycans, polysaccharides, polyesters including polyethylene terephthalate, polyacrylamides, polyethers, polyether sulfone, polycarbonate, polyalkylenes including polypropylene, polyethylene and high molecular weight polyethylene, halogenated polyalkylenes including polytetrafluoroethylene, polyurethanes, polyorthoesters, proteins, polypeptides, silicones, siloxane polymers, polylactic acid, polyglycolic acid, polycaprolactone, polyhydroxybutyrate valerate and blends and copolymers thereof as well as other biodegradable, bioabsorbable and biostable polymers and copolymers. Coatings from polymer dispersions such as polyurethane dispersions (BAYHDROL®, etc.) and acrylic latex dispersions are also within the scope of the present invention. The polymer may be a protein polymer, fibrin, collagen and derivatives thereof, polysaccharides such as celluloses, starches, dextrans, alginates and derivatives of these polysaccharides, an extracellular matrix component, hyaluronic acid, or another biologic agent or a suitable mixture of any of these, for example. In one embodiment of the invention, the preferred polymer is polyacrylic acid, available as HYDROPLUS® (Boston Scientific Corporation, Natick, Mass.), and described in U.S. Pat. No. 5,091,205, the disclosure of which is hereby incorporated herein by reference. U.S. Patent No. 5,091,205 describes medical devices coated with one or more polyisocyanates such that the devices become instantly lubricious when exposed to body fluids. In another preferred embodiment of the invention, the polymer is a copolymer of polylactic acid and polycaprolactone.

The examples described herein are merely illustrative, as numerous other embodiments may be implemented without departing from the spirit and scope of the exemplary embodiments of the present invention. Moreover, while certain features of the invention may be shown on only certain embodiments or configurations, these features may be exchanged, added, and removed from and between the various embodiments or configurations while remaining within the scope of the invention. Likewise, methods described and disclosed may also be performed in various sequences, with some or all of the disclosed steps being performed in a different order than described while still remaining within the spirit and scope of the present invention.

What is claimed is:

1. A method of coating a surface of an expandable workpiece having an inside surface and an outside surface, the method comprising:
providing an expandable workpiece having an inside surface and an outside surface;
associating the workpiece with a mold to temporarily cover at least one target surface of the workpiece with the mold;
introducing a masking material into the mold to cover at least one non-target surface of the workpiece;
separating the workpiece and masking material from the mold such that at least one target surface is not covered with masking material; and
applying a coating to a portion of the workpiece not covered with masking material.

2. The method of claim 1, wherein the expandable workpiece is a medical implant.

3. The method of claim 1, wherein the expandable workpiece is a stent.

4. The method of claim 1, further comprising the step of grounding or electrically charging the expandable workpiece.

5. The method of claim 1, wherein the coating contains therapeutic.

6. The method of claim 1, further comprising applying a second coating to a coated portion of the expandable workpiece.

7. The method of claim 1, wherein associating the workpiece with the mold includes positioning the workpiece within the mold.

8. The method of claim 1, wherein associating the workpiece with the mold includes positioning the workpiece around the mold.

9. The method of claim 1, further comprising providing a second mold.

10. The method of claim 9, wherein the coating is poured, injected, or applied via immersion into an ultrasonic bath into channels formed between the second mold and struts of the workpiece.

11. The method of claim 1, wherein the mask material does not cover an outside surface of the expandable workpiece.

12. The method of claim 1, further comprising removing the mask material from a portion of the expandable workpiece.

13. The method of claim 12, further comprising applying heat to remove mask material.

14. The method of claim 12, further comprising oscillating the expandable workpiece to remove mask material.

15. The method of claim 1, further comprising the step of selectively ablating excess coating.

16. The method of claim 1, further comprising the step of selectively ablating mask material from the expandable workpiece.

17. The method of claim 16 wherein the mask material that remains is in the form of a trapezoid.
